(19) United States
(12) Patent Application Publication
(10) Pub. No.: US 2026/0070501 A1
(43) Pub. Date: Mar. 12, 2026

(54) CONNECTOR CONNECTION STRUCTURE AND VEHICLE

(71) Applicant: Isuzu Motors Limited, Yokohama-shi (JP)

(72) Inventors: Hitoshi KOMATA, Fujisawa-shi (JP); Changwook AN, Fujisawa-shi (JP)

(73) Assignee: Isuzu Motors Limited, Yokohama-shi (JP)

(21) Appl. No.: 19/281,801

(22) Filed: Jul. 28, 2025

(30) Foreign Application Priority Data
Sep. 9, 2024 (JP) 2024-154937

(51) Int. Cl. B60R 16/02; B60K 35/50

(52) U.S. Cl. CPC B60R 16/0215; B60K 35/50

(57) ABSTRACT

A connector connection structure includes: a base material including a through-hole; and a connector to be inserted into the through-hole. The base material includes: a hole edge surface forming the through-hole penetrating the first surface and the second surface, and protrusions around the through-hole and protruding with respect to the second surface. The connector includes: a connector body, a support portion provided on an outer periphery of the connector body closer to a proximal end side than to the tip end, and one or more claw portions extending from a position closer to a tip end side of the connector body than the support portion, and is elastically deformable.

### CROSS REFERENCE TO RELATED APPLICATIONS

This application is based upon and claims the benefit of priority from prior Japanese Patent Application No. 2024-154937, filed Sep. 9, 2024, the entire contents of which are incorporated herein by reference.

### FIELD

The present invention relates generally to a connector connection structure and a vehicle.

### BACKGROUND

For example, a display is generally attached to an instrument panel of a vehicle on an inner side (front side) of the instrument panel, using an instrument panel base serving as a base material (frame) on a vehicle side. In this case, a harness hidden by the instrument panel and usually invisible to an occupant of the vehicle is routed on a back side of the display.

For example, a holding portion (harness clip) that binds and holds one or a plurality of harnesses is attached to the harness in advance. Then, the holding portion is connected to the base material on the vehicle side by a connector.

Note that Jpn. Pat. Appln. KOKAI Publication No. 2014-186807 and Jpn. Pat. Appln. KOKAI Publication No. 2000-318490 disclose a fixing structure of a wire harness. Jpn. Pat. Appln. KOKAI Publication No. 2019-78356 discloses a structure for sensing erroneous assembly of a pipe attachment clamp.

For example, in a case where the connector of the holding portion is connected to the base material, the connector can be connected from one direction of the base material in consideration of, for example, workability of a subsequent process, but there may be a case where it is desired to prevent the connector from being connected from another direction of the base material.

### SUMMARY

According to an aspect of the invention, a connector connection structure includes: a base material including a through-hole; and a connector to be inserted into the through-hole. The base material includes: a first surface, a second surface on an opposite side to the first surface, a hole edge surface forming the through-hole penetrating the first surface and the second surface, and one or more protrusions provided around the through-hole and protruding with respect to the second surface. The connector includes: a connector body insertable into the through-hole from a tip end, a support portion that is provided on an outer periphery of the connector body closer to a proximal end side than to the tip end, and one or more claw portions that extends from a position closer to a tip end side of the connector body than the support portion, and is elastically deformable. The support portion supports the first surface in a case where the tip end of the connector body is inserted into the through-hole from the first surface side. The support portion supports the protrusion in a case where the tip end of the connector body is inserted into the through-hole from the second surface side. The one or more claw portions are insertable into the through-hole in a case where the tip end of the connector body is inserted into the through-hole from the first surface side, and supporting the second surface between the claw portions and the support portion in a case where the support portion is in contact with the first surface. The one or more claw portions are disposed in the through-hole in a case where the tip end of the connector body is inserted into the through-hole from the second surface side and the support portion is in contact with the protrusion.

### BRIEF DESCRIPTION OF DRAWINGS FIG. 1 is a schematic view illustrating a part of a front portion of a vehicle according to an embodiment.

FIG. 2 is a schematic perspective view of a part of a base material illustrated in FIG. 1 as viewed from a second surface side.

FIG. 3 is a schematic front view of the part of the base material illustrated in FIG. 2 as viewed from the second surface side.

FIG. 4 is a schematic front view of a part of the base material illustrated in FIG. 1 as viewed from a first surface side.

FIG. 5 is a schematic perspective view illustrating a state in which a connector is connected to a predetermined through-hole of the base material in a connector connection structure according to the embodiment.

FIG. 6 is a schematic perspective view of the connector connection structure illustrated in FIG. 5 as viewed from the first surface side of the base material.

FIG. 7 is a schematic cross-sectional view taken along line A-A in FIG. 5.

FIG. 8 is a schematic cross-sectional view taken along line B-B in FIG. 5.

FIG. 9 is a schematic cross-sectional view corresponding to FIG. 7 in a case where the connector is to be connected from an opposite side to a predetermined direction of the base material.

FIG. 10 is a schematic cross-sectional view corresponding to FIG. 8 in a case where the connector is to be connected from an opposite side to a predetermined direction of the base material.

### DETAILED DESCRIPTION

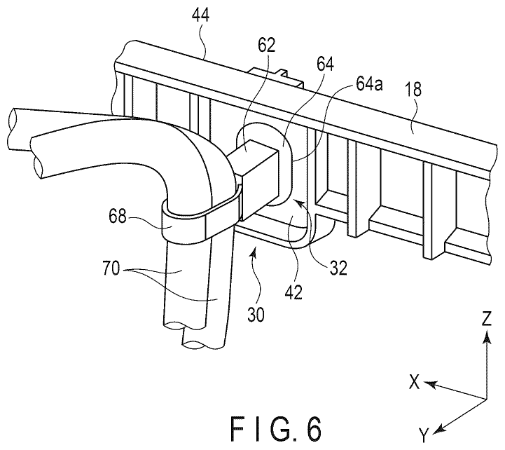

For example, one or a plurality of harnesses 70 (see FIG. 6) is routed on a back side of a display unit (display assembly) 20 fixed to a base material (instrument panel base) 18 of a vehicle 10. In the present embodiment, a connection structure (connector connection structure) 30 for connecting a connector 32 having a holding portion 68 for holding the harness (member to be held) 70 routed on the back side of a display screen 20a of the display unit 20 to the base material 18 will be described.

FIG. 1 is a schematic view of a front side of the vehicle 10 as viewed from an upper side (roof side) of the vehicle 10. An XYZ orthogonal coordinate system is given in FIG. 1. An upper side in a plane of drawing of FIG. 1 is a front side along a +Y-axis direction of the vehicle 10, a right side is a right side along a +X-axis direction of the vehicle 10, a left side is a left side along a −X-axis direction of the vehicle 10, and a lower side is a rear side along a −Y-axis direction of the vehicle 10.

Note that, in the vehicle 10 in FIG. 1, portions used for description in the embodiment are illustrated, and illustration of other portions is omitted.

Note that the vehicle 10 here may be a so-called engine vehicle, or may be any of an electric vehicle (EV), a hybrid electric vehicle (HEV), a plug-in hybrid vehicle (PHV), a fuel cell vehicle (FCV), or the like.

As illustrated in FIG. 1, the vehicle 10 has, for example, a left-side member 12, a right-side member 14, and a tubular beam 16 connecting the left-side member 12 and the right-side member 14 on the front side of the vehicle 10. The beam 16 is fixed to the left-side member 12 and the right-side member 14 with bolts or the like (not illustrated). The beam 16 may have a circular tubular shape or an appropriate polygonal tubular shape.

The base material 18 for fixing the display unit 20 to the cab side (rear side) with respect to the beam 16 is fixed to the beam 16. Then, the display unit 20 that can be visually recognized by an occupant of the vehicle 10 is fixed to the base material 18.

An instrument panel section 22 is disposed on the rear side (cab side) with respect to the beam 16.

In the present embodiment, the display unit 20 is described as being disposed at a center of the instrument panel section 22 in a width direction, but may be disposed to be shifted to the right or to be shifted to the left.

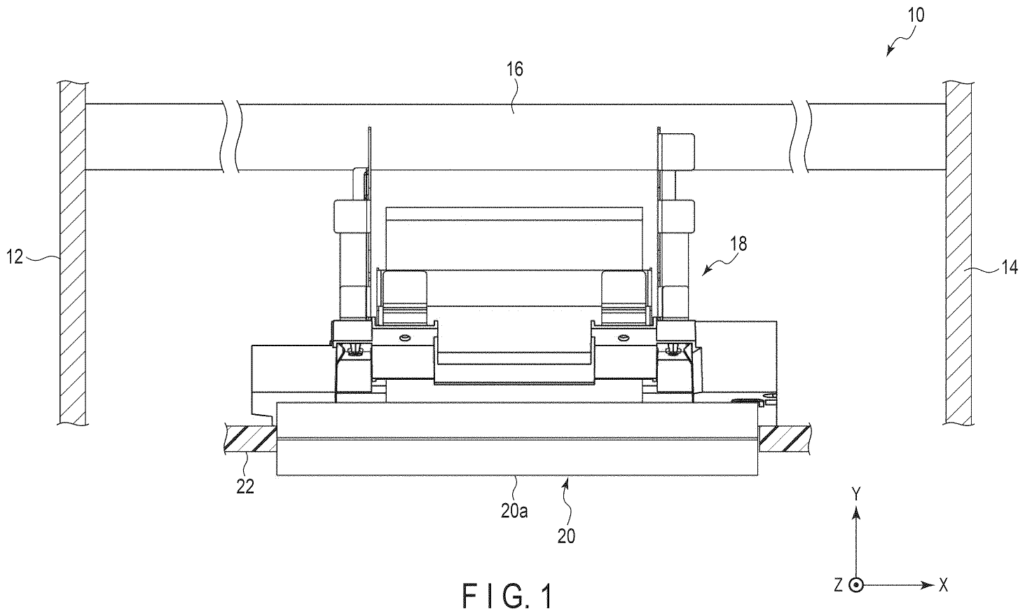

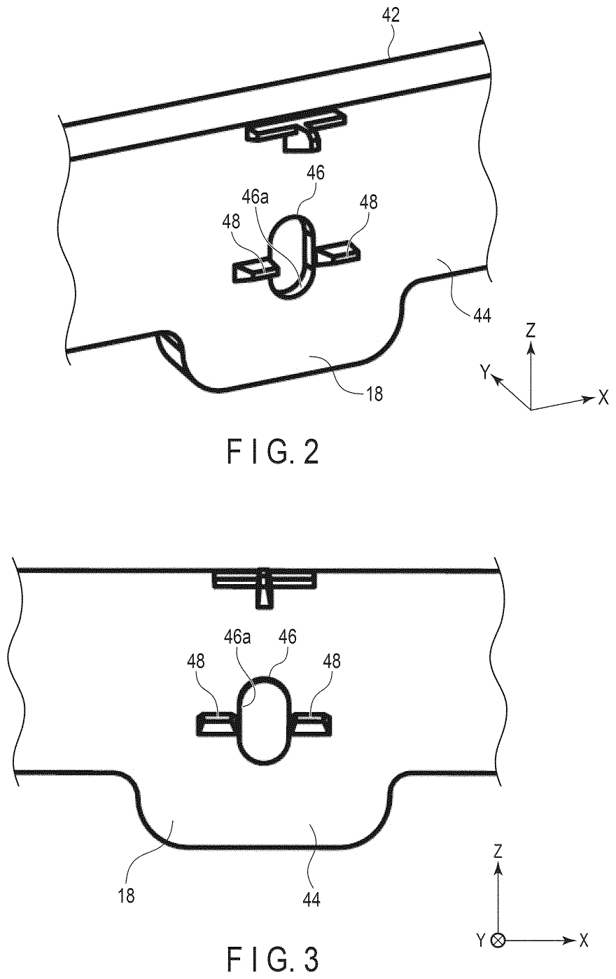

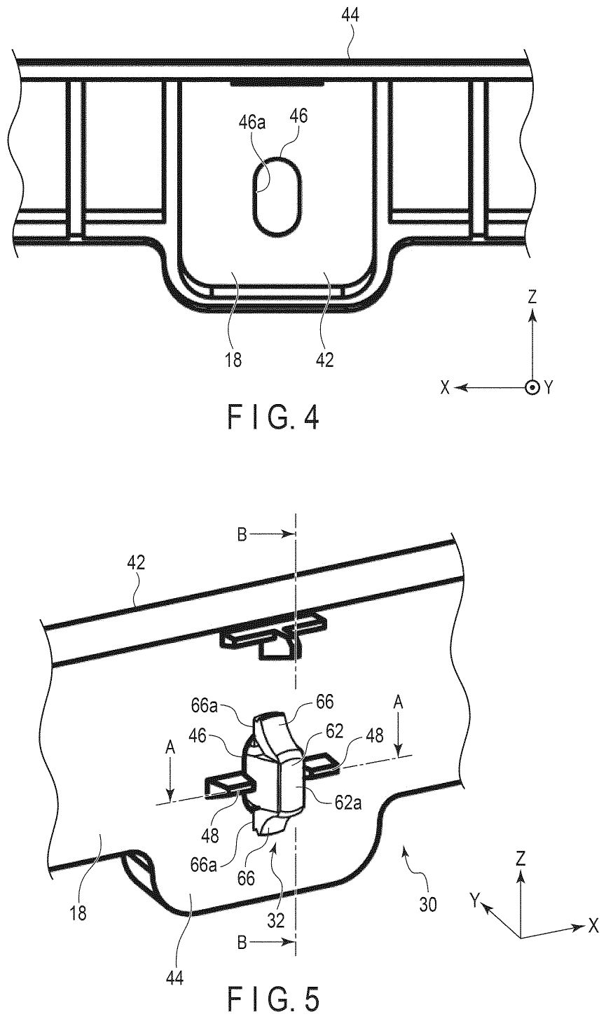

FIG. 2 is a schematic perspective view of a part of the base material 18 illustrated in FIG. 1 as viewed from a second surface 44 side. FIG. 3 is a schematic front view of a part of the base material 18 illustrated in FIG. 2 as viewed from the second surface 44 side. FIG. 4 is a schematic front view of a part of the base material 18 illustrated in FIG. 1 as viewed from a first surface 42 side, that is, as viewed from an opposite side to FIG. 3.

FIG. 5 is a schematic perspective view illustrating a state in which the connector 32 is connected to a predetermined through-hole 46 of the base material 18 in the connection structure 30 of the connector 32 according to the embodiment. Therefore, FIG. 5 is a schematic perspective view of the connection structure 30 of the connector 32 as viewed from the second surface 44 side of the base material 18. FIG. 6 is a schematic perspective view of the connection structure 30 of the connector 32 illustrated in FIG. 5 as viewed from the first surface 42 side of the base material 18.

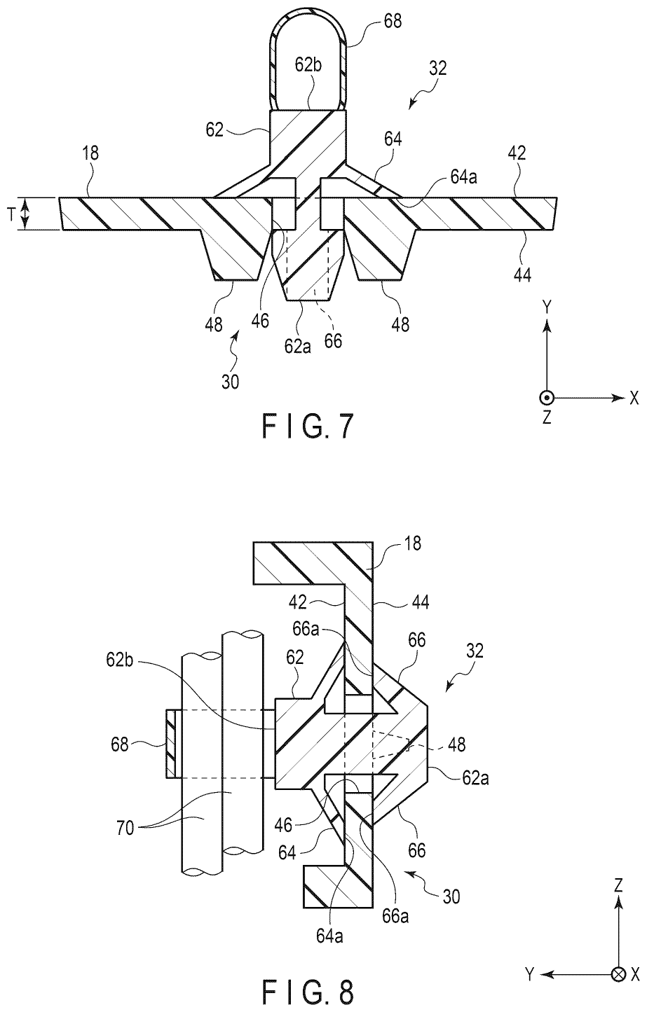

FIG. 7 is a schematic cross-sectional view taken along line A-A in FIG. 5. FIG. 8 is a schematic cross-sectional view taken along line B-B in FIG. 5.

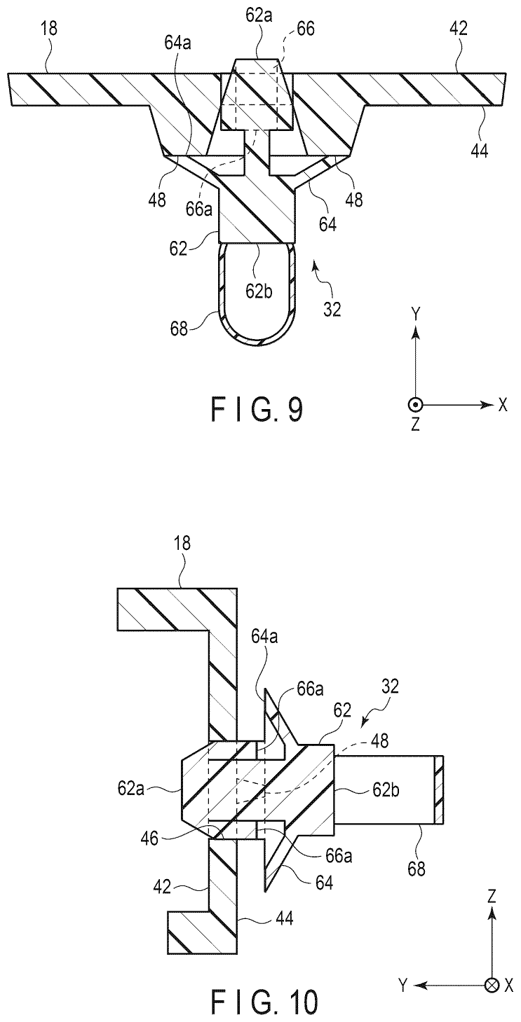

FIG. 9 is a schematic cross-sectional view corresponding to FIG. 7 in a case where the connector 32 is to be connected from an opposite side to a predetermined direction of the base material 18. FIG. 10 is a schematic cross-sectional view corresponding to FIG. 8 in a case where the connector 32 is to be connected from an opposite side to a predetermined direction of the base material 18.

Hereinafter, the connection structure (connector connection structure) 30 of the connector 32, which holds the harness 70 routed on the back side of the display screen 20a of the display unit 20 by the connector 32 and connects the connector 32 to the base material 18, will be described.

As illustrated in FIG. 5, the connection structure 30 includes the base material (vehicle-side frame) 18 and the connector 32 that can be connected from a predetermined direction of the base material 18 and cannot be connected from an opposite direction to the predetermined direction.

The base material 18 illustrated in FIGS. 2 to 4 is formed as, for example, a part of a base (IP base) for the instrument panel section 22 on the vehicle 10 side. The base material 18 may be a metal material or a resin material, but is preferably formed of a resin material.

A part of the base material 18 is formed as, for example, a plate-like member. The base material 18 includes the first surface 42, the second surface 44 opposite to the first surface 42, a hole edge surface 46a forming the through-hole 46 penetrating the first surface 42 and the second surface 44, and one or more protrusions (ribs) 48 provided around the through-hole 46 and protruding with respect to the second surface 44. The connector 32 is inserted from the first surface 42 side to the second surface 44 side.

The first surface 42 is formed as a surface on a side into which the connector 32 is to be inserted. The first surface 42 may or may not be planar.

The second surface 44 is formed as a surface on a side from which the connector 32 inserted from the first surface 42 side protrudes. The second surface 44 may or may not be planar.

The first surface 42 and the second surface 44 are preferably formed in parallel.

The through-hole 46 penetrates the first surface 42 and the second surface 44. Here, the through-hole 46 is formed as an elongated hole that penetrates in the Y-axis direction and is longer in a Z-axis direction than in the X-axis direction. The through-hole 46 has the hole edge surface 46a like a track of track and field. The hole edge surface 46a includes a pair of semicircular portions separated from each other and a rectangular portion sandwiched between the pair of semicircular portions. The through-hole 46 preferably has the same size and shape in a case where viewed from the first surface 42 side and in a case where viewed from the second surface 44 side.

Each of the protrusions 48 protrudes with respect to the second surface 44 and is adjacent to a periphery of the through-hole 46. The protrusion 48 is provided, for example, on the side of the rectangular portion of the hole edge surface 46a of the through-hole 46. In the present embodiment, the protrusions 48 face each other across an edge portion of the hole edge surface 46a of the through-hole 46. The protrusions 48 preferably have the same size and the same shape, but may have different sizes or different shapes in consideration of, for example, components disposed on the second surface 44 side.

As illustrated in FIGS. 5 to 10, the connector 32 includes a connector body 62, a support portion 64, one or more claw portions 66, and the holding portion 68.

Note that, as illustrated in FIG. 7, a distance between the first surface 42 and the second surface 44, that is, a plate thickness of the base material 18 is T.

The connector body 62 is formed as a shaft member that can pass through the through-hole 46. The connector body 62 can be inserted with a tip end 62a of the connector body 62 into the through-hole 46 from either the first surface 42 side or the second surface 44 side.

The support portion 64 is provided on an outer periphery of the connector body 62 closer to a proximal end side than to the tip end 62a. The support portion 64 is preferably formed as, for example, a flange that protrudes from the outer periphery of the connector body 62 in a direction intersecting an insertion direction of the connector body 62 into the through-hole 46. It is preferable that the support portion 64 is closer to a rear end 62b side of the connector body 62 along the Y-axis direction as closer to the outer periphery of the connector body 62, and is closer to the tip end 62a side of the connector body 62 along the Y-axis direction as farther from the outer periphery of the connector body 62.

In a case where the tip end 62a of the connector body 62 is inserted into the through-hole 46 from the first surface 42 side, the support portion 64 supports the first surface 42. On the other hand, in a case where the tip end 62a of the connector body 62 is inserted into the through-hole 46 from the second surface 44 side, the support portion 64 supports the protrusion 48 and does not reach the second surface 44. That is, in a case where the tip end 62a of the connector body 62 is inserted into the through-hole 46 from the second surface 44 side, the support portion 64 cannot support the second surface 44.

Each of the claw portions 66 extends from a position closer to the tip end 62a side of the connector body 62 than the support portion 64. In the present embodiment, the claw portion 66 extends from the tip end 62a of the connector body 62. The claw portion 66 is elastically deformable in the Z-axis direction in FIGS. 5 and 7 to 10.

In the present embodiment, the claw portion 66 includes a distal end 66a that supports the second surface 44 between the claw portion 66 and the support portion 64 in contact with the first surface 42 in a case where the tip end 62a of the connector body 62 is inserted into the through-hole 46 from the first surface 42 side.

Note that even if the claw portion 66 is elastically deformable, the distal end 66a is preferably always disposed on the rear end 62b side (holding portion 68 side) with respect to the tip end 62a of the connector body 62 in the present embodiment.

Further, the distance between the distal end 66a of the claw portion 66 and the support portion 64 is preferably formed to be substantially the same as the thickness (the distance between the first surface 42 and the second surface 44) T (see FIG. 7) of the base material 18 in an unloaded state of the connector 32. Note that the distance along the Y-axis direction between a distal end 64a of the support portion 64 and the distal end 66a of the claw portion 66 with respect to the thickness T of the base material 18 may be small or large.

The distal end 66a of the claw portion 66 is brought close to the connector body 62 by elastic deformation in a case where the tip end 62a of the connector body 62 is caused to pass through the through-hole 46 from the first surface 42 side to the second surface 44 side, and can be inserted into the through-hole 46. Then, in a case where the connector body 62 and the claw portion 66 are viewed from a tip end side with respect to the tip end 62a of the connector body 62, the connector body 62 and the claw portion 66 are formed in such sizes and shapes viewed from the tip end side that the tip end 62a of the connector body 62 passes through the rectangular portion of the through-hole 46 and the claw portion 66 passes through the pair of semicircular portions of the through-hole 46. Therefore, the connector 32 is formed in such a size and shape so as not to allow the claw portion 66 alone to pass through the rectangular portion of the through-hole 46. Therefore, the tip end 62a and the claw portion 66 of the connector body 62 are formed so as to be insertable into the through-hole 46 in a case of being oriented in a predetermined direction with respect to the elongated through-hole 46, and so as not to be insertable into the elongated through-hole 46 in a case of being rotated by, for example, 90° around an axis of the connector body 62 with respect to the above state. A rotation angle at which the connector body 62 is insertable into the elongated through-hole 46 in a case where the connector body 62 is rotated about the axis thereof is preferably about ±10°, for example, and it is preferable that the connector body cannot be inserted into the through-hole 46 in a case where the connector body is further rotated.

The distance in the Z-axis direction between the distal ends 66a of the pair of claw portions 66 is formed to be shorter than a total length of radiuses of the pair of semicircular portions and the rectangular portion of the through-hole 46 in a case where the connector 32 passes through the through-hole 46. Therefore, the claw portion 66 is insertable into the through-hole 46 together with the tip end of the connector body 62 in a case where the tip end of the connector body 62 is inserted into the through-hole 46 from the first surface 42 side. Further, the distance in the Z-axis direction between the distal ends 66a of the pair of claw portions 66 is formed to be shorter than a total length of radiuses of the pair of semicircular portions and the rectangular portion of the through-hole 46 in an unloaded state of the connector 32. For this reason, the claw portion 66 supports the second surface 44 between the claw portion 66 and the support portion 64 in a case where the support portion 64 is in contact with the first surface 42.

The claw portion 66 is disposed in the through-hole 46 without being in contact with the first surface 42 in a case where the tip end 62a of the connector body 62 is inserted into the through-hole 46 from the second surface 44 side and the support portion 64 is in contact with the protrusion (rib) 48.

The holding portion 68 is preferably provided on the rear end 62b side opposite to the tip end 62a of the connector body 62. As the holding portion 68, for example, a belt-shaped holding portion such as a binding band is used. An object to be held by the holding portion 68 can be, for example, the wire harness 70 for the vehicle 10.

FIGS. 5 to 8 illustrate a state in which the connector 32 is inserted from the first surface 42 side, which is a predetermined direction of the base material 18, and the connector 32 is engaged with the base material 18 in a desired state.

In a case where the tip end 62a of the connector body 62 is inserted into the through-hole 46 from the first surface 42 side, the claw portion 66 is directed to be separated from the base material 18 in the Z-axis direction. The claw portion 66 is biased toward the connector body 62 by elastic deformation, and the connector body 62 and the claw portion 66 pass through the through-hole 46.

Then, the distal end 64a of the support portion 64 of the connector 32 supports the first surface 42, and the distal end 66a of the claw portion 66 goes beyond the through-hole 46 and further goes beyond the second surface 44. Therefore, the distal ends 66a of the claw portions 66 are separated from each other in the Z-axis direction by elastic deformation and are brought into contact with the second surface 44. That is, as illustrated in FIGS. 7 and 8, the base material 18 is sandwiched between the distal end 66a of the claw portion 66 and the support portion 64.

FIGS. 9 and 10 illustrate a state in which the connector 32 is inserted from the second surface 44 side and the connector 32 is not engaged with the base material 18.

In a case where the tip end 62a of the connector body 62 is inserted into the through-hole 46 from the second surface 44 side, the claw portion 66 is directed to be separated from the base material 18 in the Z-axis direction. The claw portion 66 is biased toward the connector body 62 by elastic deformation, and the connector body 62 and the claw portion 66 are accommodated in the through-hole 46.

Then, the distal end 64a of the support portion 64 of the connector 32 is brought into contact with the protrusion 48 protruding with respect to the second surface 44. At this time, even if an operator pushes the connector 32, the distal end 66a of the claw portion 66 maintains the state of being disposed in the through-hole 46 and does not exceed the first surface 42. Therefore, in a case where the tip end 62a of the connector body 62 is inserted into the through-hole 46 from the second surface 44 side, the connector 32 is not engaged with the base material 18.

As described above, the connection structure 30 of the connector 32 according to the present embodiment is engaged in a case where the connector 32 is passed from the first surface 42 side of the base material 18 to the second surface 44 side through the through-hole 46, and the connector 32 can be connected to the base material 18. Therefore, in a case where the connector 32 is inserted into the through-hole 46 from a predetermined direction with respect to the base material 18, the connector 32 is engaged with the base material 18, and the connector 32 can be connected to the base material 18.

Meanwhile, the connection structure 30 of the connector 32 according to the present embodiment is not engaged in a case where the connector 32 is passed from the second surface 44 side of the base material 18 to the first surface 42 side through the through-hole 46, and the connector 32 cannot be connected to the base material 18. Therefore, in a case where the connector 32 is inserted into the through-hole 46 from the direction opposite to the predetermined direction with respect to the base material 18, the connector 32 can be prevented from being connected to the base material 18.

Therefore, according to the connection structure 30 of the connector 32 of the present embodiment, it is possible to provide the connection structure 30 of the connector 32, which can be assembled from a predetermined direction of the base material 18, can prevent assembly of the connector 32 from an opposite side of the base material 18, and can set a direction of being connected to the base material 18 to from one direction of the base material 18.

Note that the support portion 64 does not need to be provided in an annular shape in a case where the connector body 62 is inserted only in the predetermined direction due to the shape of the through-hole 46. For example, the support portion 64 may be provided, for example, in a pair of blades on opposite sides across the connector body 62.

In the present embodiment, an example in which the through-hole 46 is an elongated hole has been described. In this case, an orientation of the connector body 62 can also be set to a desired orientation.

Further, the protrusion 48 around the through-hole 46 is formed as a rib. Therefore, a strength of the base material 18 can be maintained by forming the protrusion 48 around the through-hole 46.

The through-hole 46 may be a circular hole. In this case, the support portion 64 is preferably formed as an annular flange. In a case where the through-hole 46 is a circular hole, regarding the tip end 62a of the connector body 62, in a case where the connector 32 is passed from the first surface 42 side of the base material 18 to the second surface 44 side through the through-hole 46, the distal end 66a of the claw portion 66 may not be in contact with the second surface 44 side due to interference of the protrusion 48 depending on the direction of the rotation direction of the connector 32. Even in this case, the connector 32 can be engaged with the base material 18 by rotating the connector 32 with respect to the base material 18 about the insertion direction thereof as the axis.

In the tip end 62a of the connector body 62, even if the connector 32 is passed from the second surface 44 side of the base material 18 to the first surface 42 side through the through-hole 46, the support portion 64 hits the protrusion 48. Then, the claw portion 66 is biased toward the connector body 62 side by elastic deformation and maintains a state of being accommodated in the through-hole 46. Therefore, in a case where the tip end of the connector body 62 is inserted into the through-hole 46 from the second surface 44 side, the connector 32 is not engaged with the base material 18.

In the present embodiment, an example in which the plurality of claw portions 66 extending from the tip end 62a of the connector body 62 and separated in the Z-axis direction is used as the connector 32 has been described. The claw portion 66 may be formed only on one side of the tip end 62a of the connector body 62. That is, only one claw portion 66 may be provided. At this time, the through-hole (elongated hole) 46 is preferably formed in a shape that is a combination of one semicircular portion and one rectangular portion. Then, it is possible to set the direction around the axis of the connector 32 with respect to the base material 18 to a predetermined direction while allowing the connector 32 to be connected to the base material 18 only from one direction.

The connection structure 30 of the connector 32 according to the present embodiment has been described as being used for the vehicle 10, but can be applied to an appropriate product other than the vehicle 10.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A connector connection structure comprising:
a base material including a through-hole; and
a connector to be inserted into the through-hole, wherein
the base material includes:
a first surface,
a second surface on an opposite side to the first surface,
a hole edge surface forming the through-hole penetrating the first surface and the second surface, and
one or more protrusions provided around the through-hole and protruding with respect to the second surface, and
the connector includes:
a connector body insertable into the through-hole from a tip end,
a support portion that is provided on an outer periphery of the connector body closer to a proximal end side than to the tip end,
the support portion supporting the first surface in a case where the tip end of the connector body is inserted into the through-hole from the first surface side, and
the support portion supporting the protrusion in a case where the tip end of the connector body is inserted into the through-hole from the second surface side, and
one or more claw portions that extends from a position closer to a tip end side of the connector body than the support portion, and is elastically deformable,
the one or more claw portions being insertable into the through-hole in a case where the tip end of the connector body is inserted into the through-hole from the first surface side, and supporting the second surface between the claw portions and the support portion in a case where the support portion is in contact with the first surface, and
the one or more claw portions being disposed in the through-hole in a case where the tip end of the connector body is inserted into the through-hole from the second surface side and the support portion is in contact with the protrusion.

2. The connection structure according to claim 1, wherein
the through-hole is formed to be an elongated hole, and
the tip end and the claw portion of the connector body are configured to insert into the through-hole in a case where the tip end and the claw portion are oriented in a predetermined direction with respect to the elongated hole.

3. The connection structure according to claim 1, wherein
the claw portion includes a distal end that supports the second surface between the claw portion and the support portion in contact with the first surface, and
the distal end is brought close to the connector body by elastic deformation and is insertable into the through-hole in a case where the tip end is caused to pass through the through-hole from the first surface side to the second surface side.

4. The connection structure according to claim 1, wherein
the plurality of protrusions faces each other across an edge portion of the through-hole.

5. The connection structure according to claim 1, wherein
the support portion includes a flange protruding in a direction intersecting an insertion direction of the connector body with respect to the through-hole.

6. A vehicle comprising: the connection structure according to claim 1.
